(19) United States
(12) Patent Application Publication
(10) Pub. No.: US 2023/0381549 A1
(43) Pub. Date: Nov. 30, 2023

(54) RESERVOIR FOR HYBRID SCBA

(71) Applicant: Createc, LLC, Branford, CT (US)

(72) Inventors: Hans O. Almqvist, Lidingo (SE); Imre Botos, Tystberga (SE)

(73) Assignee: Createc, LLC, Branford, CT (US)

(21) Appl. No.: 18/308,021

(22) Filed: Apr. 27, 2023

Related U.S. Application Data
(60) Provisional application No. 63/338,343, filed on May 4, 2022.

(51) Int. Cl. A62B 7/02; A62B 9/00; A62B 9/02

(52) U.S. Cl. CPC A62B 7/02; A62B 9/006; A62B 9/02

(57) ABSTRACT

A SCBA with an air storage, a face piece with inner mask (nose cup), breathing regulator(s), a breathing valve, an exhalation valve operating at positive pressure relative to the ambient and a reservoir capable of storing the first part of an exhalation and delivering that part at the subsequent inhalation. The reservoir is positioned in the SCBA's face piece or in close proximity thereto, is in fluid contact with the inner mask, and has a shut-off valve controlled by a carbon-dioxide sensor. The operating pressure of the reservoir is maintained above ambient pressure and the operating pressure of the reservoir is between the opening pressure of the SCBA's breathing valve and the SCBA's exhalation valve.

### CROSS-REFERENCE TO RELATED APPLICATION

This application claims priority from U.S. Provisional Application Ser. No. 63/338,343, filed May 4, 2022, the entire contents of which is incorporated herein by reference.

### BACKGROUND OF THE INVENTION

A Self-Contained Breathing Apparatus (SCBA) comprises a face mask with an inner mask (nose cup), pressure regulator(s) and a source of breathing gas with oxygen as a main active component. SCBAs are used for work in contaminated atmospheres. Historically, SCBAs have been of either Open-Circuit or Closed-Circuit type with the basic difference that in an Open-Circuit SCBA, the exhalation is vented to the surroundings, while in a Closed-Circuit SCBA, the exhalation is cleaned in a carbon-dioxide absorber and re-used. Most SCBAs maintain a positive pressure in the face mask to avoid in-leakage from the ambient atmosphere. Such SCBAs are mandatory for fire service.

By introducing a SCBA according to U.S. Pat. No. 11,185,650 B2 (“the '650 patent”), which is incorporated herein by this reference, a variant of the existing SCBA became available. It is called Hybrid SCBA. A key component in a Hybrid SCBA is a reservoir or “breathing bag” that collects the first part of the exhalation for re-use in the following breath. More specifically, the breathing gas in the trachea, mouth, and nose cup in the end of each inhalation does not enter the lungs, so that it remains substantially free from carbon dioxide, and can, be collected and used for rebreathing. The '650 patent shows a Hybrid SCBA that collects the initial portion of each exhalation in a reservoir for rebreathing and, when a carbon dioxide detector determines that the carbon dioxide content of the exhalation has reached a certain level, or that the volume of exhaled breathing gas has reached a predetermined volume, vents the remainder of the exhalation to the ambient atmosphere. In this way the breathing gas is used most efficiently.

The design and function of the reservoir is essential for the efficiency of a Hybrid SCBA and is the topic of the current patent application.

### SUMMARY OF THE INVENTION

The reservoir or breathing bag is shown at 67 in FIG. 7 of the '650 patent. It has several functions:
To collect the exhalation up to a pre-determined amount.
To allow measurement and control of carbon dioxide concentration.
To maintain positive pressure in relation to the ambient atmosphere.
To allow for delivering its full amount of breathing gas at the subsequent inhalation.

As the process time, that is, the length of one inhalation/exhalation cycle, is about two to three seconds, there are requirements in the following areas:
The position of the reservoir relative to the face piece of the SCBA.
The position and activation speed of the carbon dioxide sensor and valve control element.
The need to have a shut-off valve for the reservoir.
These are the areas of the following detailed description.

### BRIEF DESCRIPTION OF THE DRAWINGS

The invention will be better understood with reference to the accompanying drawings, in which:

FIG. 1 shows a preferred design and position of a reservoir according to the invention;

FIG. 2 shows a cross-sectional view of a preferred design of the reservoir and its different components;

FIGS. 3A and 3B show side and top views of an exemplary design for a “butterfly” type valve;

FIGS. 4A and 4B show side and top views of an exemplary design for a “flapper” type valve;

FIG. 5 is a diagram showing the pressure in the facepiece versus flowrate for one inhalation/exhalation cycle;

FIG. 6 shows a cross-sectional view of the reservoir in a slightly modified embodiment; and

FIG. 7 shows another version of the reservoir, again in cross-sectional view.

### DETAILED DESCRIPTION OF THE PREFERRED EMBODIMENT

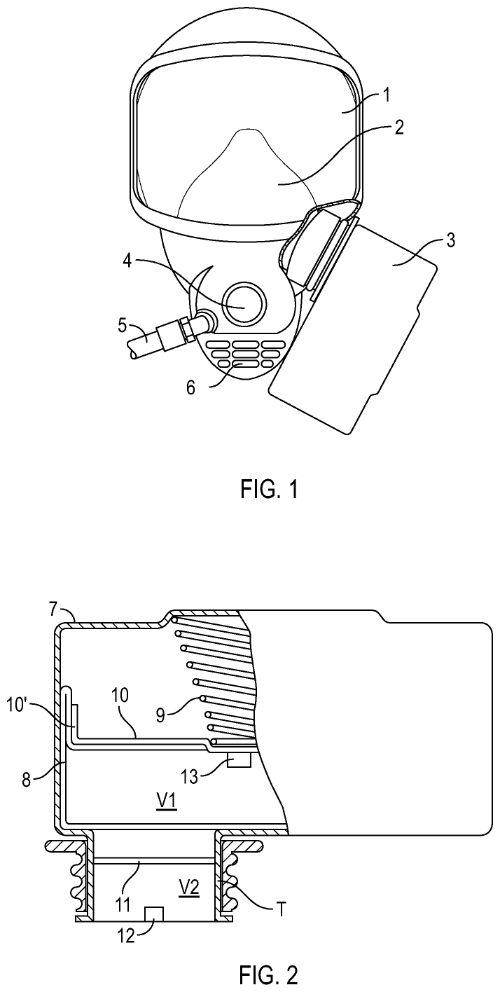

One example of a preferred design and position of a reservoir 3 is shown in FIG. 1. The reservoir 3 can be an integral part of the face piece 1, but for clarity is shown here as a separate, connected, removable unit. Other components in FIG. 1 that are mentioned below are the breathing regulator 4 that supplies fresh breathing gas from a supply hose 5 and an exhalation valve 6. Typically, the regulator 4 comprises two regulators in series, the first reducing the pressure in the breathing gas supply tank to on the order of 7 bar and the second to just above ambient pressure; the second regulator may also serve as a breathing valve, admitting breathing gas to the nose cup.

The reservoir 3 is disposed in close proximity to the nose cup 2 in order to reduce the volume of gas space between the nose cup and the reservoir. This minimization of the “dead space” is preferred in order to minimize the volume of carbon dioxide-rich exhaled breathing gas that remains at the end of each exhalation and that is re-inhaled at the subsequent inhalation. More specifically, the dead space is the volume in nose cup, mouth and trachea and some of the dead space volume is required for comfort and to provide the ability to communicate, The necessity of a connection to the reservoir involves an additional volume, which is undesirable because any exhaled breathing gas with high carbon dioxide content collected here is re-inhaled. Accordingly, the additional volume should be kept small. Furthermore, reducing the dead space as much as possible makes it possible to efficiently separate the early part of the exhalation from the latter part and to measure and control the carbon dioxide content in the inlet of the reservoir 3 without significant time lag.

Stated differently, upon the beginning of each exhalation, the “dead space” comprised by the mouth, trachea and nose cup is filled with breathing gas that has not entered the lungs and is accordingly carbon dioxide-lean. This portion of the exhalation is therefore captured in the reservoir and rebreathed on the next inhalation. However, at the end of the exhalation the dead space is full of carbon dioxide-rich breathing gas which is also rebreathed at the successive inhalation. (The same would be true of a non-hybrid SCBA, of course, so that this fact is not a deficiency of the hybrid SCBA.) Therefore it is desirable to minimize the volume of the dead space as much as possible, and to dispose the dead space as close to the nose cup as feasible.

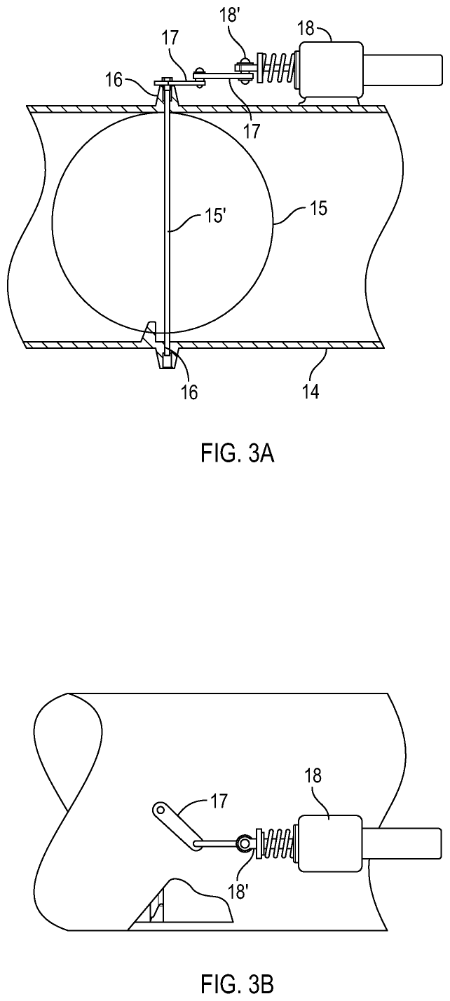

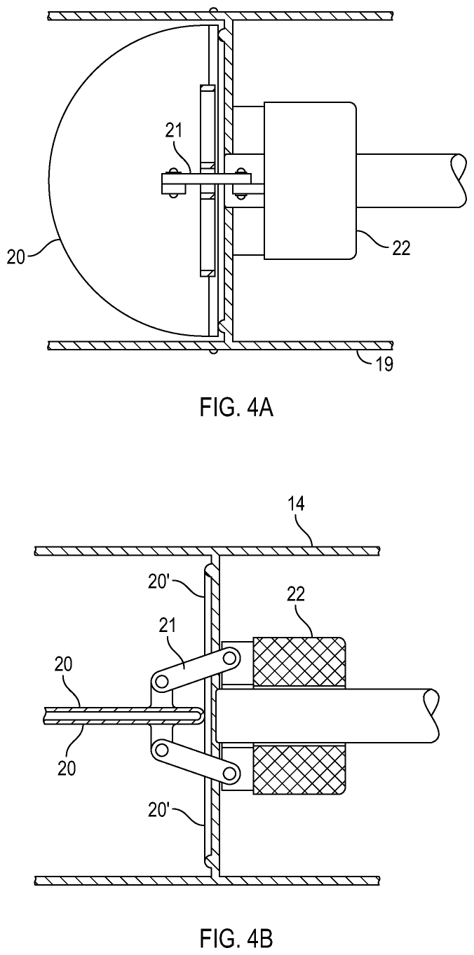

FIG. 2 shows a preferred design of the reservoir 3 in partial cross-section and its different components. The air collecting part consists of a variable volume vessel 7 of cylindrical shape having a rolling diaphragm 8 as offered by Bellofram Corp. of Newell WV as its outer wall. Typical dimensions for the reservoir 3 are 110 mm in diameter and 65 mm in height, for a volume V1 of 0.6 liter, enough to contain the exhaled breathing gas in the nose cup, mouth and trachea that has not reached the lungs during inhalation. The pressure in the volume V1 is maintained above ambient, to correspond with the positive pressure in the face piece, by a spring 9 acting on a circular plate 10 which moves to control the interior volume V1 in which the initial portion of the exhalation is collected for rebreathing. A second “additional” volume V2 is defined by the interior of the tube T by which the reservoir is connected to the nose cup. Its dimensions should not exceed 30 mm in diameter by 50 mm long, for a volume of 0.03 liters, to minimize the additional volume as discussed above. A shut-off valve 11 (several embodiments of which are discussed in detail below) in the inlet of the reservoir (that is, connected to the face plate 1 and in fluid contact with the inner mask (nose cup) 2) is controlled to be open or closed by an electronic control unit, not shown, responsive to the carbon dioxide content of the exhalation. A carbon dioxide sensor can be placed in the inlet of the reservoir 3 as shown at 12 or on the cylindrical plate 10, as indicated at 13. The shut-off valve 11 can have the form of a butterfly valve as shown in FIGS. 3A and 3B or of a flap valve as shown in FIGS. 4A and 4B.

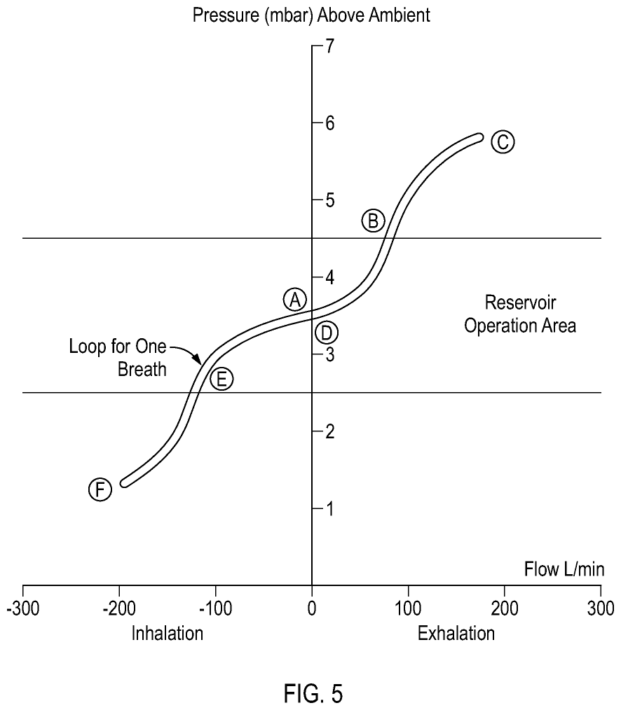

To explain the function of one preferred mode (Mode A) of the device, reference is made to the Pressure/Flow diagram FIG. 11 in the '650 patent, here repeated in more detail as FIG. 5. Note that, while the inhalation pressure (on the left side of FIG. 5) is less than the exhalation pressure (on the right side of FIG. 5), all pressures are positive in relation to the ambient, so that no inflow of air from the surroundings can occur. Note also with reference to FIG. 5 that the reservoir has its own operating area and that the supply of fresh breathing gas occurs at pressures below that area and the venting of air to the surroundings occur at pressures above that area. Starting at zero flow at the beginning of an inhalation, the reservoir 3 delivers the first portion of the breathing gas to the user. When the reservoir 3 is empty, the rest of the inhalation is supplied from the breathing valve at a lower positive pressure. That is, the breathing gas pressure is below the operating area of the reservoir. Upon the commencement of exhalation, the first part of the exhaled breathing gas fills the reservoir 3 to a predetermined volume as discussed below. The remainder of the exhalation is vented to the surroundings at a higher pressure through the exhalation valve, that is, the breathing pressure is above the operating area of the reservoir.

More specifically, a human breath starts, both at inhalation and exhalation, at zero flow rate and accelerates gradually to a maximum peak flow rate. It then slows gradually until it reaches zero flow rate again. As shown by FIG. 5, an exhalation starts at point A at which point the reservoir 3 is open and the exhaled breathing gas flows into the reservoir 3. At point B the reservoir 3 is full and the pressure increases above the operating area of the reservoir. At a higher breathing pressure, the exhalation valve opens and releases the remaining part of the exhalation to the surroundings. At point C the exhalation reaches its peak flow. It then slows down until the flow rate reaches zero, at point D. Likewise, the inhalation starts at point D and either the shut-off valve opens or, because of the lower pressure created by the user's inhalation, the stored breathing gas in the reservoir 3 flows into the user's mouth. At point E, the reservoir 3 is empty and the breathing pressure reaches the activation pressure of the breathing regulator and delivers the remaining of the inhalation. At point F the inhalation flow reaches its peak and slows down until it reaches zero flow at point A.

As discussed further below, the device can be operated in two modes, termed A and B. In mode A the CO₂ sensor 13 is positioned inside the reservoir (FIG. 2), and its function is to close the shut-off valve when the CO₂ level in the reservoir reaches dangerous levels for re-breathing. The shut-off valve is held closed for a predetermined time, say 10 seconds, temporarily converting the SCBA to an open circuit unit. In mode B the CO₂ sensor 12 is positioned inside the tubular conduit connecting the reservoir to the nose piece, and is employed to close the shut-off valve when the CO₂ content in the reservoir has reached an optimal value for efficiently utilizing the fresh breathing gas, this being termed the “trigger point”.

### Design of the Shut-Off Valve

The shut-off valve 11 (see FIG. 2) can have any of several designs. Two examples are given, a butterfly valve in FIGS. 3A and 3B and a flap valve in FIGS. 4A and 4B.

FIGS. 3A and 3B show a butterfly valve that has two positions, fully open and fully closed. FIG. 3A shows a partly cross-sectional side elevational view and FIG. 3B a view from the top of FIG. 3A. In this embodiment, shut-off valve 11 has the following components:
14—Cylindrical tube connected to the reservoir 3
15—Circular valve disc mounted on an axle 15′
16—Axle supports that hold the circular disc 15 and allow the disc 15 to rotate 90 degrees
17—Lever that controls the disc's position, open or closed
18—Electromagnetic solenoid activated responsive to a signal from the carbon dioxide sensor (not shown) so as to operate lever 17 and thus the position of disc 15.

Thus, in use of the Hybrid SCBA, the valve 11 is opened upon the beginning of each exhalation so as to collect the initially-exhaled breathing gas in the reservoir 3, and closed to discharge the remainder of each exhalation to the ambient. The valve connecting the face piece to the ambient is of the check valve type, set to open as the pressure in the face piece increases.

Solenoid 18 may be spring-biased as illustrated to the closed position for safety; that is, if the CO₂ level in the reservoir has reached dangerous values, the valve is closed at a predetermined time and the device operates as a conventional open-circuit SCBA.

FIGS. 4A and 4B show a flap valve that has two positions, fully open and fully closed. FIG. 4A shows a partly cross-sectional side elevational view and FIG. 4B a view from the top of FIG. 4A. FIG. 4B shows in the flaps in the open position at 20 and in the closed position in dashed lines at 20′. In this embodiment, shut-off valve 11 has the following parts:
19=Cylindrical tube connected to the reservoir
20=Two half-circular flaps
21=Linkage to move the flaps 20 between fully open and fully closed positions
22=Electromagnetic solenoid that is activated responsive to a signal from the carbon dioxide sensor (not shown) to operate linkage 21 and thus to control the position of flaps 20.

Operation is as described with reference to FIGS. 3A and 3B.

### Alternative Designs of the Reservoir

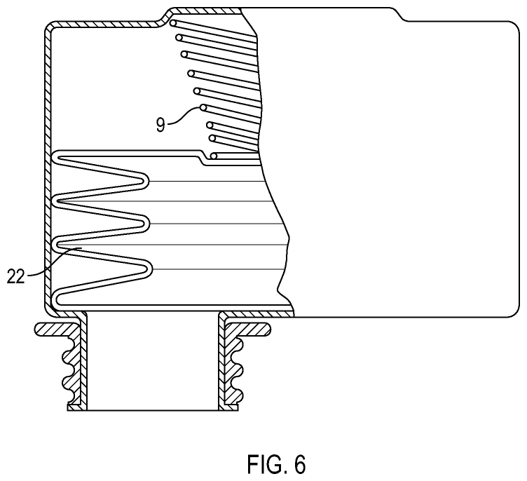

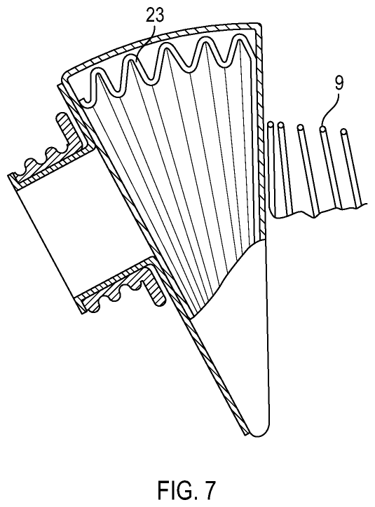

The rolling diaphragm shown in FIG. 2 at 8 can be replaced by other means to store exhalation gas and release it at the next breath. We here show two examples: FIG. 6 shows a cylindrical bellows 22 and FIG. 7 a pivoting bellows 23. In both cases the other components, spring 9 to maintain a positive pressure in the bellows, a shut-off valve to open and close the bellows, etc. are as shown in FIG. 2. Those of skill in the art would have no difficulty in adapting these alternative embodiments.

### Different Control Methods of the Volume of the Reservoir

Two methods of controlling the volume of the reservoir 3 and thereby the amount of rebreathed air are discussed below.

In the first method, designated mode B, the carbon dioxide sensor is located at the inlet of the reservoir 3, as shown in FIG. 2 at 12. Sensor 12 measures the carbon dioxide concentration during the exhalation with very high speed and accuracy, and at a predetermined value, termed the “trigger point”, sensor 12 provides a signal to the shut-off valve to close, as described in connection with FIGS. 3A and 3B and FIGS. 4A and 4B. The predetermined value of the carbon dioxide trigger point takes into consideration the content of the reservoir 3, the carbon dioxide concentration of the breathing gas in the cavities of the nose cup, mouth and trachea, and the volume of fresh air supplied from the breathing valve, based on previous breaths, with the purpose to get the optimal concentration of carbon dioxide in the lungs for most effective utilization of the breathing gas. In this design, the volume of the breathing gas supplied from the reservoir 3 varies with the user's differing workload. This is the preferred design for most effective utilization of the supplied breathing gas and consequently gives the longest duration of work given a certain amount of stored breathing gas.

In the second method, designated mode A above, the reservoir is set at a constant volume independent of the user's workload. Consequently, this volume is what is saved and re-breathed at each breath. The savings of breathing gas is optimal only for one specific workload, but if an average workload is well determined, this design still can give considerable breathing gas savings. For this design, the carbon dioxide sensor is positioned inside the Reservoir as shown in FIG. 2 at 13 and will act to close the shut-off valve only if the carbon dioxide reaches levels too dangerous to be re-breathed. It will be appreciated that the response time for the carbon dioxide sensor in this case can be considerably slower, one second or more, compared to the first method described above.

### The Size of the Reservoir

It is possible that the size of the reservoir can be disturbing for the user. The remedy is to split the reservoir into two sections, one of each side of the face piece. In this case, only one reservoir section will need to have a shut-off valve. That is, one reservoir section will capture an initial portion of the carbon dioxide-free initial exhalation, and the second section will capture the reminder, venting the carbon dioxide containing portion of the exhalation to the ambient. The order in which the two reservoirs act can be based on pressure differences or by mechanical or electronic means or combinations thereof. As an example, if pressure differences are used as control criteria, the two reservoir sections would have different operation area according to FIG. 5, one upper and one lower and not overlapping.

1. A SCBA comprising a source of pressurized breathing gas, a face piece with inner mask (nose cup), breathing regulator(s), an exhalation valve operating at positive pressure relative to the ambient and a reservoir capable of storing the first part of an exhalation and delivering that part at the subsequent inhalation, wherein said reservoir specifically:
is positioned in the SCBA's face piece or in close proximity thereto,
is in fluid contact with and in close proximity to the inner mask, and
has a shut-off valve controlled by a carbon-dioxide sensor, and wherein
the operating pressure of the reservoir is controlled to be above ambient pressure; and
the operating pressure of the reservoir is controlled to be between the opening pressures of the breathing valve and the exhalation valve.

2. The SCBA of claim 1 wherein the carbon-dioxide sensor is positioned in the inlet of the reservoir, and wherein the shut-off valve is operated to close the reservoir when the carbon dioxide content of the exhalation has reached a predetermined value, and wherein a latter portion of an exhalation is discharged to the ambient via the exhalation valve.

3. The SCBA of claim 1 wherein the carbon-dioxide sensor is positioned inside the reservoir. and wherein the shut-off valve is operated to close the reservoir when the carbon dioxide content of the exhalation reaches levels too dangerous to be re-breathed and wherein a latter portion of an exhalation is discharged to the ambient via the exhalation valve.
